(19) United States
(12) Patent Application Publication
(10) Pub. No.: US 2025/0192453 A1
(43) Pub. Date: Jun. 12, 2025

(54) CLAMP FOR CONDUCTORS

(71) Applicant: ERICO International Corporation, Solon, OH (US)

(72) Inventors: Thomas E. Bendlak, Macedonia, OH (US); David J. Shibilia, Cincinnati, OH (US); Andrew T. Zwit, Cincinnati, OH (US)

(21) Appl. No.: 18/975,667

(22) Filed: Dec. 10, 2024

Related U.S. Application Data
(60) Provisional application No. 63/608,452, filed on Dec. 11, 2023.

(51) Int. Cl. H01R 4/44; F16L 3/04; H01R 4/64

(52) U.S. Cl. CPC H01R 4/44; H01R 4/643; F16L 3/04

(57) ABSTRACT

A clamp assembly for securing a conductor can include a first plate with a first groove having a first width transverse to a first groove axis and a first protrusion extending away from the first groove and forming a recessed channel disposed outside of the first groove. The clamp assembly can further include a second plate with a second groove having a second width transverse to a second groove axis and a pair of second protrusions extending away from the second groove, each second protrusion of the pair forming a recessed channel disposed outside of the second groove. In an installed configuration the first protrusion is arranged between the pair of second protrusions relative to an elongate direction of the first and second grooves to deform the conductor around the first protrusion.

### CROSS-REFERENCE TO RELATED APPLICATIONS

This application claims the benefit of U.S. Provisional Application No. 63/608,452, filed Dec. 11, 2023, which is hereby incorporated by reference in its entirety.

### BACKGROUND

Clamps may be used to secure one or more conductors for grounding and bonding applications. For example, pipe clamps may be used in pipe or conduit bonding, fence post or gate bonding, raised floor pedestal bonding, underground reinforcement steel (e.g., rebar) bonding, or lightning protection systems. However, in some cases, traditional clamps may be unable to generate sufficient clamping force to retain the conductor (e.g., a wire, conduit, cable, etc.) within the clamp during use, which may result in a poor connection or bond between the clamp and the conductor.

### SUMMARY

Some aspects of the disclosure provide a clamp assembly for securing a conductor. The clamp assembly can include a clamp having a first plate having a first engagement surface that includes a first groove defining a first groove axis, a second plate having a second engagement surface that includes a second groove defining a second groove axis, and a fastener extending through the first plate and the second plate to adjustably reduce a spacing between the second plate and the first plate, to clamp a conductor between the first engagement surface and the second engagement surface with the conductor extending along the first groove and the second groove. The first protrusion can extend from the first groove to engage the conductor at a distal end of the first protrusion that protrudes outside of the first groove with an elongated width transverse to the first groove axis. A second protrusion can extend from the first groove to engage the conductor at a distal end of the second protrusion that protrudes outside of the first groove with an elongated width transverse to the first groove axis. And, a third protrusion can extend from the second groove to engage the conductor at a distal end of the third protrusion that protrudes outside of the second groove with an elongated width transverse to the second groove axis. The distal end of one or more of the first, second, or third protrusions can define a recessed channel oriented to receive the conductor.

Some aspects of the disclosure can provide the clamp assembly of any previous aspect in which the third protrusion is arranged between the first protrusion and the second protrusion relative to a direction along the first or second groove axis.

Some aspects of the disclosure can provide the clamp assembly of any previous aspect in which, in an installed configuration, the first protrusion and the second protrusion protrude to deform the conductor around the third protrusion.

Some aspects of the disclosure can provide the clamp assembly of any previous aspect in which the distal end of each of the second protrusion and the third protrusion, respectively, includes angled surfaces defining a V-shape of the recessed channel, oriented to contact the conductor.

Some aspects of the disclosure can provide the clamp assembly of any previous aspect in which the distal end of each of the first protrusion, the second protrusion, and the third protrusion, respectively, includes angled surfaces defining a V-shaped channel oriented to contact the conductor.

Some aspects of the disclosure can provide the clamp assembly of any previous aspect in which angled surfaces of the V-shaped channel at least partially surround an exterior of the conductor.

Some aspects of the disclosure can provide the clamp assembly of any previous aspect in which the second groove is included in a plurality of grooves on the second plate to selectively receive the conductor in cooperation with the first groove, the plurality of grooves further including a third groove substantially parallel to the second groove, a fourth groove substantially perpendicular to the first and third grooves, and a fifth groove substantially parallel to the fourth groove.

Some aspects of the disclosure can provide the clamp assembly of any previous aspect in which a protrusion extends, respectively, from each of the third, fourth, and fifth grooves, to a distal end that protrudes outside of the corresponding third, fourth, or fifth groove to engage the conductor.

Some aspects of the disclosure provide a method of installing a clamp assembly. The method can include aligning a conductor between a first groove of a first engagement surface of a first plate of the clamp, and a second groove of a second engagement surface of a second plate of the clamp, with a first protrusion and a second protrusion extending from the first groove toward the conductor and a third protrusion extending from the second groove toward the conductor, adjusting a fastener extending through the first plate and the second plate to reduce a spacing between the second plate and the first plate, to clamp the conductor between the first engagement surface and the second engagement surface with the conductor extending along the first groove and the second groove, and with the conductor engaged by a distal end of the first protrusion that extends outside of the first groove with an elongated width transverse to a first groove axis of the first groove, a distal end of the second protrusion that extends outside of the first groove with an elongated width transverse to the first groove axis, and a distal end of the third protrusion that extends outside of the second groove with an elongated width transverse to a second groove axis of the second groove. The distal end of one or more of the first, second, or third protrusions can define a recessed channel oriented to contact the conductor.

Some aspects of the disclosure can provide the method of any previous aspect in which adjusting the fastener deforms the conductor with the third protrusion between the first protrusion and the second protrusion.

Some aspects of the disclosure can provide the method of any previous aspect in which the conductor is deformed by a respective recessed channel on each of the first, second, and third protrusions.

Some aspects of the disclosure can provide the method of any previous aspect in which the recessed channel is defined by angled surfaces of the one or more of the first, second, or third protrusions, extending from a midpoint of the distal end along the elongate width, and in which the conductor is centered within relative to the first and second grooves by the angled surfaces to be secured between the first engagement surface and the second engagement surface.

Some aspects of the disclosure can provide the method of any previous aspect in which the angled surfaces of the recessed channel extend to opposing sides of the corresponding first or second groove axis to at least partially surround an exterior of the conductor.

Some aspects of the disclosure can provide the method of any previous aspect further including selectively aligning the conductor between the first groove of the first plate and one of a plurality of grooves on the second plate, the plurality of grooves including the second groove, a third groove substantially parallel to the second groove, a fourth groove substantially perpendicular to the first and third grooves, and a fifth groove substantially parallel to the fourth groove, and engaging the conductor via at least one protrusion that extends, respectively, from each of the third, fourth, and fifth grooves, to a distal end that protrudes outside of the corresponding third, fourth, or fifth groove to engage the conductor.

Some aspects of the disclosure can provide the method of any previous aspect further including selectively securing a pair of conductors within the clamp, with a first conductor arranged between the first groove of the first plate and the second groove of the second plate, and a second conductor arranged between a sixth groove of the first plate and the third groove of the second plate so that the conductors are arranged in parallel, on opposing sides of the fastener.

Some aspects of the disclosure provide a clamp assembly for securing a conductor including a first plate with a first groove having a first width transverse to a first groove axis and a first protrusion extending away from the first groove and forming a recessed channel disposed outside of the first groove. The clamp assembly can further include a second plate with a second groove having a second width transverse to a second groove axis and a pair of second protrusions extending away from the second groove, each second protrusion of the pair forming a recessed channel disposed outside of the second groove. In an installed configuration the first protrusion can be arranged between the pair of second protrusions relative to an elongate direction of the first and second grooves to deform the conductor around the first protrusion.

Some aspects of the disclosure can provide the clamp assembly of any previous aspect in which one or more of the recessed channels include angled surfaces that define a V-shaped channel that extends to opposite sides of the corresponding first or second groove axis.

Some aspects of the disclosure can provide the clamp assembly of any previous aspect in which the first protrusion defines a width that is wider than a width of the first groove.

Some aspects of the disclosure can provide the clamp assembly of any previous aspect in which the second groove is included in a plurality of grooves on the second plate to selectively receive the conductor in cooperation with the first groove, the plurality of grooves further including a third groove substantially parallel to the second groove, a fourth groove substantially perpendicular to the first and third grooves, and a fifth groove substantially parallel to the fourth groove.

Some aspects of the disclosure can provide the clamp assembly of any previous aspect in which a protrusion extends, respectively, from each of the third, fourth, and fifth grooves, to a distal end that protrudes outside of the corresponding third, fourth, or fifth groove to engage the conductor.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a clamp according to aspects of the present disclosure.

FIG. 2 is an exploded view of the clamp of FIG. 1.

FIG. 3 is a side view of a clamping assembly of the clamp of FIG. 1.

FIG. 4 is an axonometric view of a first plate of the clamp of FIG. 1.

FIG. 5 is a side view of the first plate of FIG. 4.

FIG. 6 is an axonometric view of a second plate of the clamp of FIG. 1.

FIG. 7 is a side view of the second plate of FIG. 6.

FIG. 8 is a side view of the clamp of FIG. 1 including a conductor secured within the clamp.

FIG. 9 is a side view of another example of a clamp.

FIG. 10 is a side view of another example of a clamp.

FIG. 11 is a side view of another example of a clamp.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As generally noted above, it may be beneficial to increase the amount of force required to remove a conductor from within a clamp (e.g., a pipe clamp). Further, in grounding and bonding applications, it may be beneficial to maximize the connection strength between the clamp and the conductor (e.g., to avoid electrical shorts, etc.). In one example, a clamp (e.g., a pipe clamp) may include a clamping assembly configured to receive and retain one or more conductors (e.g., wire, conduit, cable, etc.). The clamping assembly may include a first plate and a second plate arranged opposite the first plate. In one example, the second plate may be adjusted relative to the first plate via an adjustable fastener to clamp the conductor between an engagement surface of the first plate and an engagement surface of the second plate.

In one example, the first plate may include one or more protrusions extending away from the engagement surface. The protrusions may be positioned within and extending out of one or more grooves (e.g., parallel grooves) defined by the engagement surface of the first plate or may otherwise protrude to engage conductors at location spaced apart from the relevant engagement surface. In one example, the protrusions may define a width that is substantially equal to a width of the grooves. In one example, the protrusions may have elongated widths transverse to a corresponding groove or conductor (i.e., may exhibit an aspect ratio with a larger dimension transverse to an axis of the groove or conductor than along the axis of the groove or conductor).

In one example, the first plate may include a single protrusion on each side of a clamping portion of the plate (e.g., four protrusions for four sides). In another example, the second plate may include one or more protrusions extending away from the engagement surface (e.g., to engage a conductor from an opposite direction than a protrusion from the first plate).

As noted above, the protrusions may be positioned within and extend out of one or more grooves defined by the engagement surface of the second plate. For example, the protrusions may define a width that is substantially equal to a width of the grooves on one or both plate. In one example, the second plate may include a pair of protrusions (e.g., one on each end of the groove). In one particular example, a protrusion of the first plate is oriented to approximately bisect a distance between a pair of protrusions of the second plate.

In one example, the protrusions (e.g., protrusions on first plate and second plate) may include a pair of angled surfaces forming a V-shaped channel configured to center and retain the conductor, or distal recessed channels to engage a conductor can exhibit other geometries (e.g., being U-shaped or otherwise smoothly curved, etc.). In another example, the protrusions may include a planar (e.g., flat) surface.

In use, the user may insert the conductor between the engagement surfaces of the first and second plates and then adjust (e.g., rotatably tighten) the adjustable fastener to drive the second plate towards the first plate until the protrusions of the first and second plates contact the conductor. Following this, the user may continue to adjust the adjustable fastener to drive the protrusions of the second plate into the conductor and thereby deform (e.g., crimp or otherwise bend) the conductor around the protrusion of the first plate. Thus, the clamp can increase the force required to remove the conductor from the clamp, without separating strands of the conductor, which may lead to decreased conductivity or a poor connection.

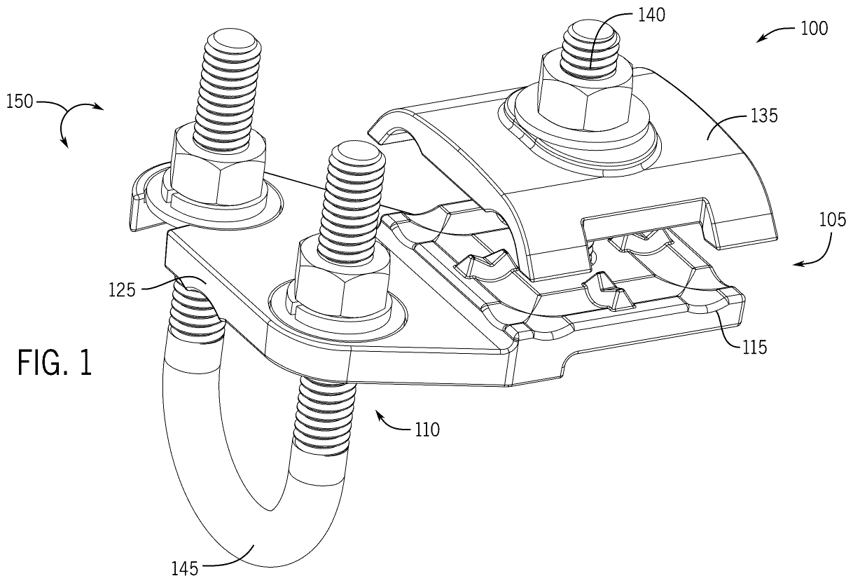

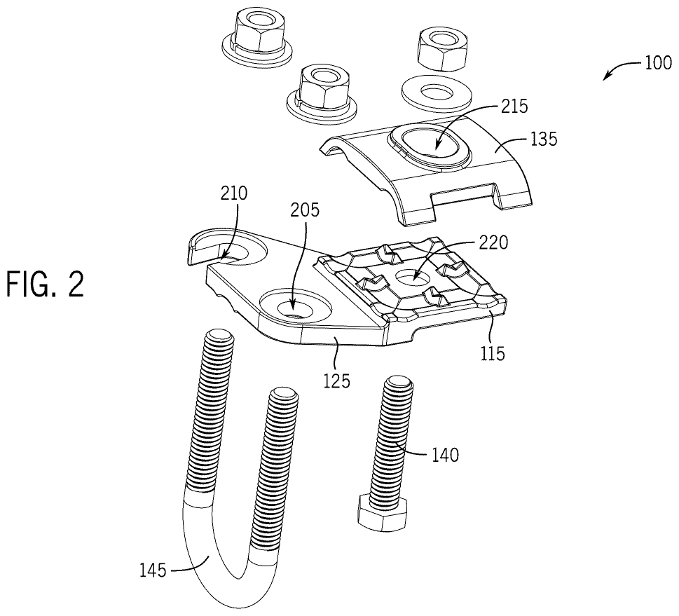

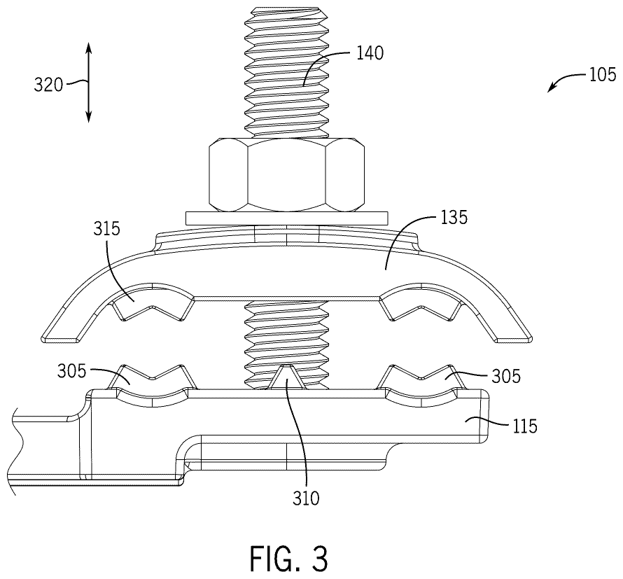

FIGS. 1-3 illustrate an example of a clamp 100 for retaining one or more electrical conductors (e.g., conduit, wire, cable, etc.). The clamp 100 may include a clamping assembly 105 configured to receive and retain the one or more electrical conductors. The clamp 100 may further include a mounting assembly 110 configured to secure the clamp 100 to a pipe, post, or other mounting location.

In one example, the clamp 100 may include a first plate 115 having a mounting bracket 125. The mounting bracket 125 may include an aperture 205 configured to receive a portion of a fastener 145 (e.g., a first leg of a U-bolt). Correspondingly, the mounting bracket 125 may include a cutout 210 configured to selectively receive another portion (e.g., a second leg of the U-bolt) of the fastener 145. In one particular example, the fastener 145 may be in the form of a U-bolt configured to permit a user to secure the clamp 100 to a pipe or other tubular mounting location. To facilitate ease of mounting of the clamp 100, the cutout 210 may permit rotational movement of the fastener 145 about a pivot axis formed by the fastener 145 through the aperture 205 as shown by arrow 150. Thus, a user does not have to remove the fastener 145 from the mounting bracket 125 in order to mount the clamp 100 to a desired mounting location. Instead, the user may loosen the fastener 145 and rotate the fastener 145 as shown by arrow 150. Then the user may arrange the fastener 145 around the desired mounting location and rotate the clamp 100 such that the fastener 145 is within the cutout 210. Following this, the user may tighten the fastener 145 to secure the clamp 100 to the mounting location.

As mentioned previously, the first plate 115 may work in combination with a second plate 135 to receive and retain one or more conductors (e.g., conduit, wire, cable, etc.) within the clamp 100. In one example, the first plate 115 and the second plate 135 may be tightened (e.g., moved nearer each other) or loosened (e.g., moved further from each other) as shown by arrow 320. For example, the first plate 115 and second plate 135 may be tightened or loosened via an adjustable fastener 140 arranged through both thru hole 215 defined by the second plate 135 and a corresponding thru hole 220 defined by the first plate 115. For example, during use, a user may arrange one or more conductors within the clamping assembly 105 of the clamp 100 (e.g., between the first plate 115 and the second plate 135) and then tighten the adjustable fastener 140 to bring the second plate 135 nearer to the first plate 115, thus tightening or clamping the one or more conductors within the clamp 100. Correspondingly, a user may loosen the adjustable fastener 140 to separate or move the second plate 135 further from the first plate 115, thus loosening or unclamping the one or more conductors from within the clamp 100.

To mitigate the risk of the one or more conductors separating from (e.g., becoming loose or unclamped from) the clamp 100. The first plate 115 and the second plate 135 may each include one or more protrusions configured to grip the one or more conductors. For example, the first plate 115 may include one or more protrusions 305, which may be arranged on opposing parallel sides of the first plate 115. Correspondingly, the first plate 115 may include one or more protrusions 310, which may be arranged on opposing parallel sides of the first plate 115, but perpendicular to the protrusions 305. Put differently, the protrusions 305 may be parallel to each other but perpendicular to the protrusions 310 and vice versa. In another example, the second plate 135 may include one or more protrusions 315 arranged on opposing parallel sides of the second plate 135. In one example, the second plate 135 may be rotatable about an axis formed by the adjustable fastener 140, such that the protrusions 315 of the second plate 135 may be arranged in various positions as desired by a user.

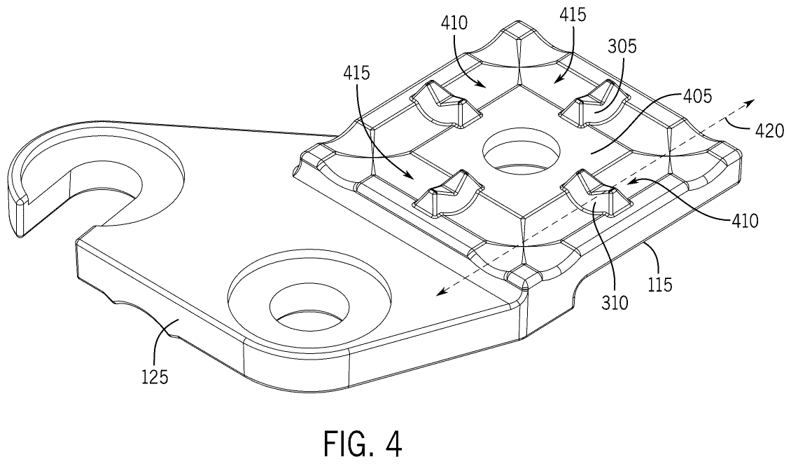

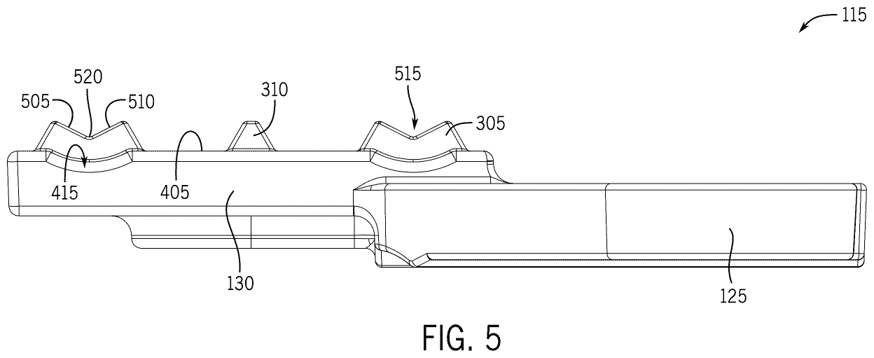

Looking now at FIGS. 4 and 5, the first plate 115 includes an engagement surface 405 defining a first pair of parallel grooves 410 and a second pair of parallel grooves 415. In some examples, the grooves 410, 415 may each include a groove axis, which may be defined along an elongate direction of the groove (e.g., as shown by arrow 420). Thus, when a conductor is arranged within the clamp, the conductor may be said to be arranged along the groove axis of the groove. In one example, the first and second pairs of parallel grooves 410, 415 may be arranged perpendicular to each other (e.g., forming a substantially rectangular shape). In one example, the protrusions 305 and the protrusions 310 may be arranged in about the center of the grooves. For example, the protrusions 305 may be arranged in about the center of the second pair of parallel grooves 415, while the protrusions 310 may be arranged in about the center of the first pair of parallel grooves 410. In another example, the protrusions 305 and the protrusions 310 may each define a width that is substantially equal to a width of the grooves 410, 415 and extends across (e.g., perpendicular to) the groove axis. In another example, the protrusions 305 and the protrusions 310 may each define a width that is greater than the width of the grooves 410, 415.

In one particular example, the protrusions 305 and the protrusions 310 may include a non-planar surface profile configured to center and retain the one or more conductors. For example, the protrusions 305 and the protrusions 310 may include a pair of angled surfaces 505, 510 together forming a V-shaped channel 515. In some examples, the angled surfaces 505, 510 may originate at an origin point 520 (e.g., the furthest recessed portion of the protrusions), which may be substantially aligned with a midpoint of the grooves. In one example, the channel 515 may be configured to center or align the conductors within the clamp 100. In another example, the channel 515 may be configured to cradle the one or more conductors when retained within the clamp 100 to prevent splaying or separation of one or more strands of the conductor (e.g., wire or cable conductors).

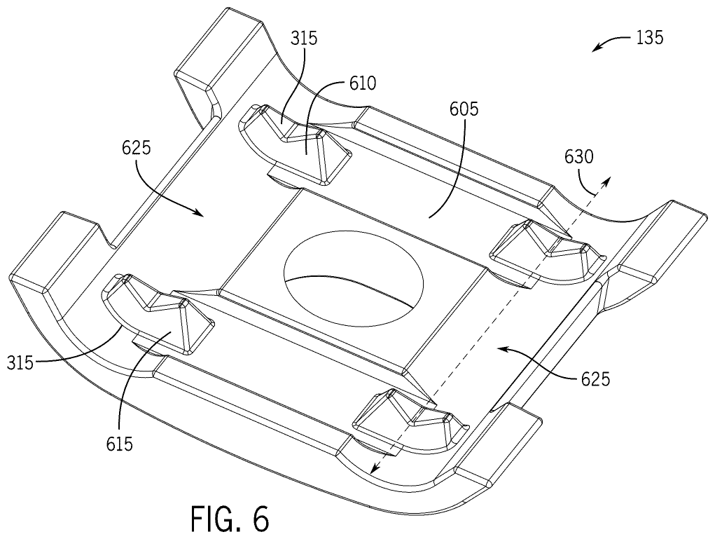

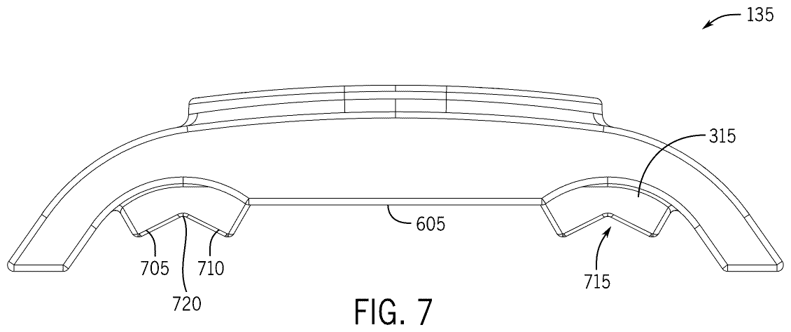

FIGS. 6 and 7 show one example of the second plate 135, which includes an engagement surface 605 defining a pair of parallel grooves 625. In some examples, the grooves 625 may each include a groove axis, which may be defined along an elongate direction of the groove (e.g., as shown by arrow 630). Thus, when a conductor is arranged within the clamp, the conductor may be said to be arranged along the groove axis of the groove. In one example, the protrusions 315 may be arranged at about the ends of the grooves 625. For example, the second plate 135 may include a pair of protrusions 315 arranged at either end of the grooves 625. For example, the second plate 135 may include a first protrusion 610 arranged at a first end of the grooves 625. Correspondingly, the second plate 135 may include a second protrusion 615 arranged at a second, opposite end of the grooves 625. Thus, in one example, when the second plate 135 is tightened down onto the first plate 115 (e.g., via the adjustable fastener 140) the first protrusion 610 and the second protrusion 615 may be arranged outside (e.g., straddling) the protrusions 305 or the protrusions 310 of the first plate 115. Thus, the protrusions 305 or the protrusions 310 may substantially bisect the first protrusion 610 from the second protrusion 615 when the second plate 135 is tightened down onto the first plate 115.

In some examples, the first protrusion 610 and the second protrusion 615 may each define a width that is substantially equal to a width of the grooves 625 (e.g., in a direction perpendicular to the groove axis). In another example, the protrusions 610, 615 may each define a width that is greater than the width of the grooves 625. Further, the first protrusion 610 and the second protrusion 615 may include a non-planar surface profile configured to center and retain the one or more conductors. For example, the first protrusion 610 and the second protrusion 615 may include a pair of angled surfaces 705, 710 together forming a V-shaped channel 715. In some examples, the angled surfaces 705,710 may originate at an origin point 720 (e.g., the furthest recessed portion of the protrusions), which may be substantially aligned with a midpoint of the grooves. In one example, the channel 715 may be configured to center or otherwise align the conductors relative to the relevant protrusion 315. In another example, the channel 715 may be configured to cradle the one or more conductors when retained within the clamp 100 to prevent splaying or separation of one or more strands of the conductor (e.g., wire or cable conductors).

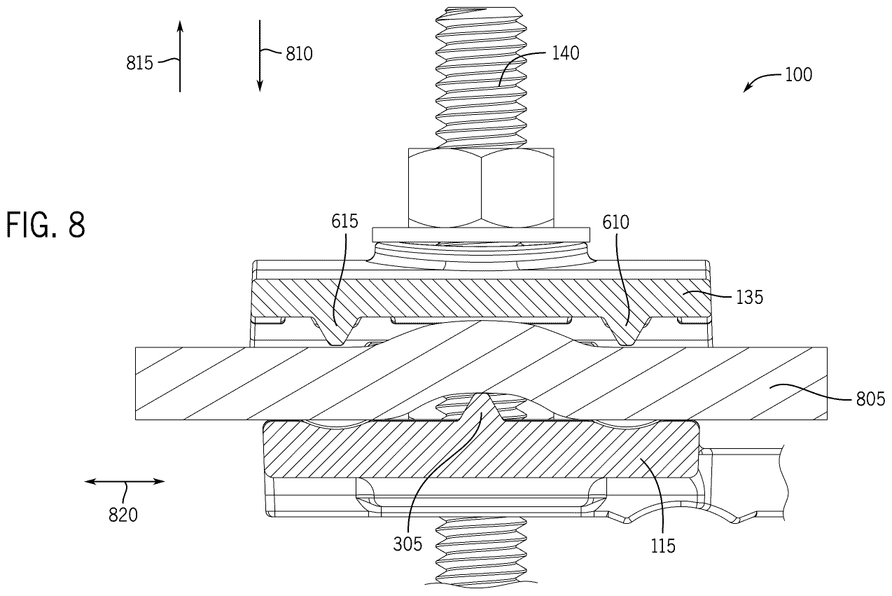

FIG. 8 shows an example of one or more conductors 805 secured within the clamp 100. As mentioned previously, the clamp 100 may be configured to secure more than one conductor simultaneously (e.g., via corresponding pairs of grooves). In one example, the conductors 805 may be arranged parallel to each other via corresponding grooves 410, 415. Additionally, depending on which pairs of grooves 410, 415 that a user decides to use on the first plate 115, the position of the second plate 135 may be adjusted (e.g., via rotation of the second plate 135) to align the first protrusion 610 and the second protrusion 615 with the conductor 805. Further, depending on which pairs of the grooves 410, 415 that a user decides to use on the first plate 115, the conductors 805 may be oriented parallel to or perpendicular to the fastener 145. In another example, a user may utilize only a single of the grooves 415 and only a single of the grooves 410 such that the conductors 805 may be oriented perpendicular to each other rather than parallel to each other.

In one example, the user may insert the conductor 805 within an opening defined between the engagement surfaces of the first plate 115 and the second plate 135 (e.g., when the first plate 115 and the second plate 135 are separated). For example, the user may insert the conductor 805 with the conductor 805 arranged or resting on the protrusions 305 (or the protrusions 310 depending on the desired orientation of the conductor 805). In one example, due to the channel 515 of the protrusions 305 or the protrusions 310, the conductor 805 may be automatically centered on the protrusions 305 or the protrusions 310.

Following this, the user may begin to drive the second plate 135 towards the first plate 115 (e.g., as shown by arrow 810) via the adjustable fastener 140. Once the first protrusion 610 and the second protrusion 615 of the second plate 135 contact the conductor 805, the channels 715 of the first protrusion 610 and the second protrusion 615 automatically center the conductor 805. As the user continues to tighten the adjustable fastener 140, the first protrusion 610 and the second protrusion 615 apply a force to the conductor 805 in the direction shown by arrow 810, while the protrusions 305 (or the protrusions 310) apply an opposing force to the conductor 805 in the direction shown by arrow 815. As a result, the conductor 805 deforms (e.g., bends) around the protrusions 305 (or the protrusions 310). In one example, deformation of the conductor 805 around the protrusions 305 increases the force required (e.g., force in the direction shown by arrow 820) to remove the conductor 805 from the clamp 100. Further, on larger diameter conductors, the angled surfaces 705, 710 of the protrusions 315 and the angled surfaces 505, 510 of the protrusions 305 or protrusions 310 may dig into the conductor 805 to further retain the conductor 805, without separating the strands of the conductor 805. Thus, the clamp 100 is able to meet or exceed current Underwriters Laboratories (UL) standards.

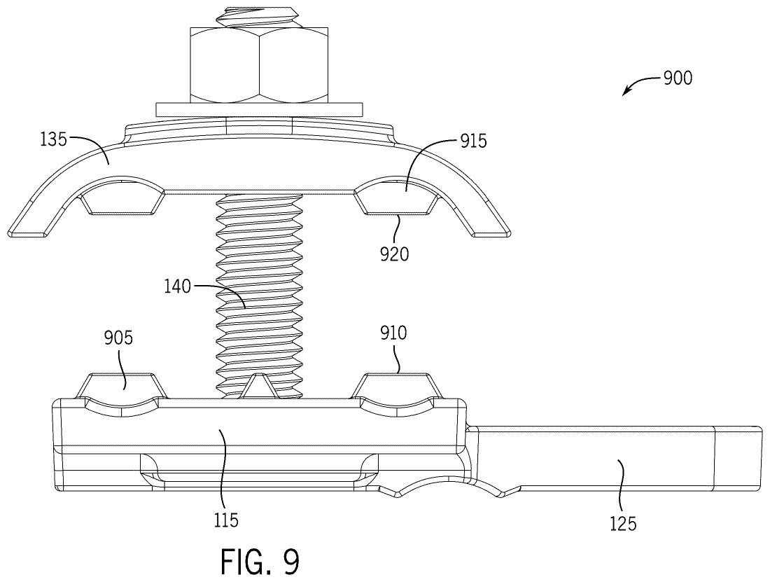

FIG. 9 illustrates another example of a clamp 900. As will be recognized, the clamp 900 shares a number of components in common with and operates in a similar fashion to the examples illustrated and described previously (e.g., the clamp 100). For the sake of brevity, these common features will not be again described below in detail. Rather, previous discussion of commonly named or numbered features, unless otherwise indicated, also applies to example configurations of the clamp 900.

In one example, the first plate 115 of the clamp 900 may include protrusions 905 having a planar (e.g., flat) surface 910. Correspondingly, the second plate 135 of the clamp 900 may include protrusions 915 having a planar surface 920. In one example, the planar surface 910 and the planar surface 920 of the protrusions 905 and the protrusions 915 may be configured to increase force transfer between the protrusions 905 and the protrusions 915 and the conductor 805 to deform the conductor 805 during a clamping operation.

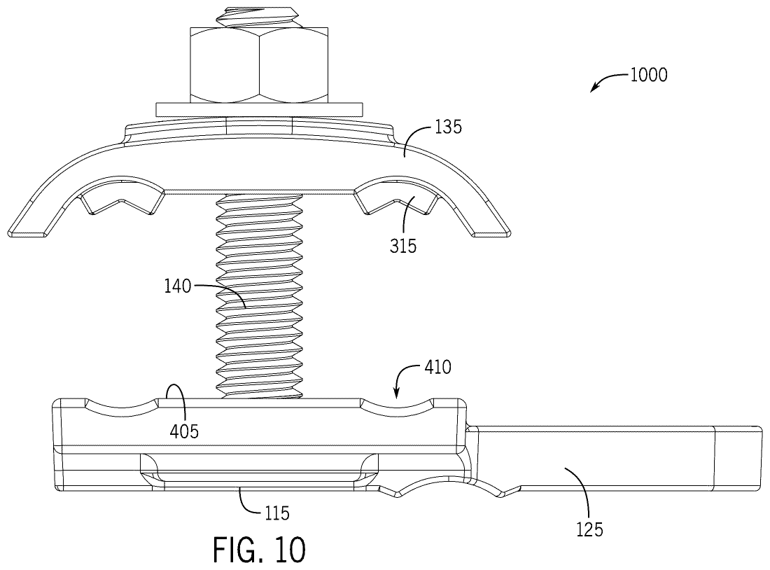

FIG. 10 illustrates another example of a clamp 1000. As will be recognized, the clamp 100 shares a number of components in common with and operates in a similar fashion to the examples illustrated and described previously (e.g., the clamp 100, the clamp 900). For the sake of brevity, these common features will not be again described below in detail. Rather, previous discussion of commonly named or numbered features, unless otherwise indicated, also applies to example configurations of the clamp 1000.

In one example, the first plate 115 of the clamp 1000 may include only the grooves 410 (and the grooves 415) instead of the protrusions 305, 310, or protrusions 905 described previously. However, the second plate 135 of the clamp 100 may include the protrusions 315 as described previously (e.g., including the V-shaped channel). Thus, when the conductor 805 is inserted and clamped within the clamp 1000, the conductor 805 is not deformed as described previously. Instead, the protrusions 315 of the second plate 135 clamp the conductor 805 between the surface of the grooves 410 (or grooves 415) and the channel 715 of the protrusions 315 to retain the conductor 805 within the clamp 1000.

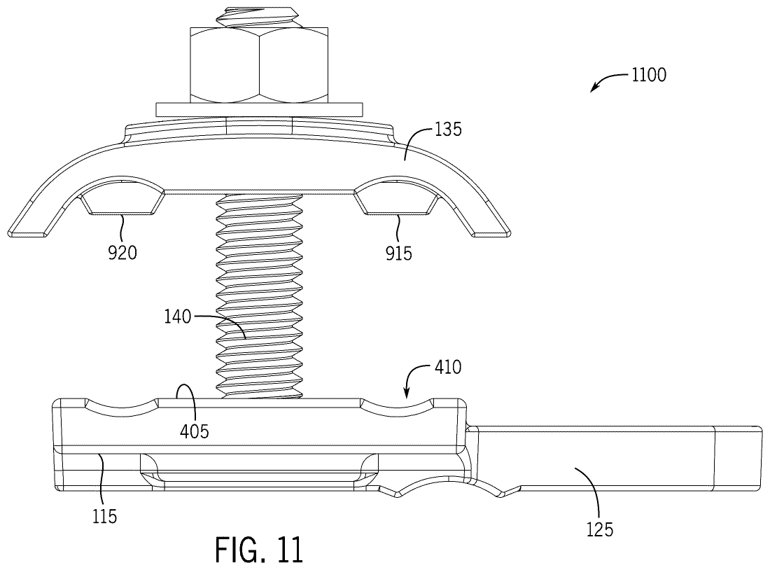

FIG. 11 illustrates another example of a clamp 1100. As will be recognized, the clamp 1100 shares a number of components in common with and operates in a similar fashion to the examples illustrated and described previously (e.g., the clamp 100, the clamp 900, the clamp 1000). For the sake of brevity, these common features will not be again described below in detail. Rather, previous discussion of commonly named or numbered features, unless otherwise indicated, also applies to example configurations of the clamp 1100.

In one example, the first plate 115 of the clamp 1100 may include only the grooves 410 (and the grooves 415) instead of the protrusions 305, 310, or protrusions 905 described previously. However, the second plate 135 of the clamp 100 may include the protrusions 915 as described previously (e.g., including the planar surface). Thus, when the conductor 805 is inserted and clamped within the clamp 1100, the conductor 805 is not deformed as described previously. Instead, the protrusions 915 of the second plate 135 clamp the conductor 805 between the surface of the grooves 410 (or grooves 415) and the planar surface 920 of the protrusions 915 to retain the conductor 805 within the clamp 1000.

As should be appreciated, any of the above-described versions of the second plate 135 may be used with any of the above-described versions of the first plate 115. For example, the first plate 115 having the protrusions 905 with the planar surface 910 may be combined with the second plate 135 having the protrusions 315 with the V-shaped channel 715 and vice versa.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±25% or less, inclusive of the endpoints of the range. Similarly, the term “substantially equal” (and the like) as used herein with respect to a reference value refers to variations from the reference value of less than +15%, inclusive. Where specified, “substantially” can indicate in particular a variation in one numerical direction relative to a reference value. For example, “substantially less” than a reference value (and the like) indicates a value that is reduced from the reference value by 15% or more, and “substantially more” than a reference value (and the like) indicates a value that is increased from the reference value by 15% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A clamp assembly for securing a conductor, the clamp assembly comprising:
a clamp including:
a first plate having a first engagement surface that includes a first groove defining a first groove axis;
a second plate having a second engagement surface that includes a second groove defining a second groove axis; and
a fastener extending through the first plate and the second plate to adjustably reduce a spacing between the second plate and the first plate, to clamp a conductor between the first engagement surface and the second engagement surface with the conductor extending along the first groove and the second groove;
a first protrusion extending from the first groove to engage the conductor at a distal end of the first protrusion that protrudes outside of the first groove with an elongated width transverse to the first groove axis;
a second protrusion extending from the first groove to engage the conductor at a distal end of the second protrusion that protrudes outside of the first groove with an elongated width transverse to the first groove axis; and
a third protrusion extending from the second groove to engage the conductor at a distal end of the third protrusion that protrudes outside of the second groove with an elongated width transverse to the second groove axis; and
the distal end of one or more of the first, second, or third protrusions define a recessed channel oriented to receive the conductor.

2. The clamp assembly of claim 1, wherein the third protrusion is arranged between the first protrusion and the second protrusion relative to a direction along the first or second groove axis.

3. The clamp assembly of claim 2, wherein, in an installed configuration, the first protrusion and the second protrusion protrude to deform the conductor around the third protrusion.

4. The clamp assembly of claim 1, wherein the distal end of each of the second protrusion and the third protrusion, respectively, includes angled surfaces defining a V-shape of the recessed channel, oriented to contact the conductor.

5. The clamp assembly of claim 1, wherein the distal end of each of the first protrusion, the second protrusion, and the third protrusion, respectively, includes angled surfaces defining a V-shaped channel oriented to contact the conductor.

6. The clamp assembly of claim 5, wherein angled surfaces of the V-shaped channel at least partially surround an exterior of the conductor.

7. The clamp assembly of claim 1, wherein the second groove is included in a plurality of grooves on the second plate to selectively receive the conductor in cooperation with the first groove, the plurality of grooves further including:
a third groove substantially parallel to the second groove;
a fourth groove substantially perpendicular to the first and third grooves; and
a fifth groove substantially parallel to the fourth groove.

8. The clamp assembly of claim 7, wherein a protrusion extends, respectively, from each of the third, fourth, and fifth grooves, to a distal end that protrudes outside of the corresponding third, fourth, or fifth groove to engage the conductor.

9. A method of installing a clamp assembly, the method comprising:
aligning a conductor between a first groove of a first engagement surface of a first plate of the clamp, and a second groove of a second engagement surface of a second plate of the clamp, with a first protrusion and a second protrusion extending from the first groove toward the conductor and a third protrusion extending from the second groove toward the conductor;
adjusting a fastener extending through the first plate and the second plate to reduce a spacing between the second plate and the first plate, to clamp the conductor between the first engagement surface and the second engagement surface with the conductor extending along the first groove and the second groove, and with the conductor engaged by:
a distal end of the first protrusion that extends outside of the first groove with an elongated width transverse to a first groove axis of the first groove;
a distal end of the second protrusion that extends outside of the first groove with an elongated width transverse to the first groove axis; and
a distal end of the third protrusion that extends outside of the second groove with an elongated width transverse to a second groove axis of the second groove;
the distal end of one or more of the first, second, or third protrusions defining a recessed channel oriented to contact the conductor.

10. The method of claim 9, wherein adjusting the fastener deforms the conductor with the third protrusion between the first protrusion and the second protrusion.

11. The method of claim 10, wherein the conductor is deformed by a respective recessed channel on each of the first, second, and third protrusions.

12. The method of claim 9, wherein the recessed channel is defined by angled surfaces of the one or more of the first, second, or third protrusions, extending from a midpoint of the distal end along the elongate width; and
wherein the conductor is centered within relative to the first and second grooves by the angled surfaces to be secured between the first engagement surface and the second engagement surface.

13. The method of claim 12, wherein the angled surfaces of the recessed channel extend to opposing sides of the corresponding first or second groove axis to at least partially surround an exterior of the conductor.

14. The method of claim 9, further comprising:
selectively aligning the conductor between the first groove of the first plate and one of a plurality of grooves on the second plate, the plurality of grooves including:
the second groove;
a third groove substantially parallel to the second groove;
a fourth groove substantially perpendicular to the first and third grooves; and
a fifth groove substantially parallel to the fourth groove; and
engaging the conductor via at least one protrusion that extends, respectively, from each of the third, fourth, and fifth grooves, to a distal end that protrudes outside of the corresponding third, fourth, or fifth groove to engage the conductor.

15. The method of claim 14, further comprising:
selectively securing a pair of conductors within the clamp, with a first conductor arranged between the first groove of the first plate and the second groove of the second plate, and a second conductor arranged between a sixth groove of the first plate and the third groove of the second plate so that the conductors are arranged in parallel, on opposing sides of the fastener.

16. A clamp assembly for securing a conductor, the clamp assembly comprising:
a first plate, including:
a first groove having a first width transverse to a first groove axis; and
a first protrusion extending away from the first groove, the first protrusion forming a recessed channel disposed outside of the first groove; and
a second plate, including:
a second groove having a second width transverse to a second groove axis; and
a pair of second protrusions extending away from the second groove, each second protrusion of the pair forming, respectively, a recessed channel disposed outside of the second groove;
with the clamp assembly in an installed configuration that clamps a conductor having a least the first width or the second width, the first protrusion being arranged between the pair of second protrusions relative to an elongate direction of the first and second grooves to deform the conductor around the first protrusion.

17. The clamp of claim 16, wherein one or more of the recessed channels include angled surfaces that define a V-shaped channel that extends to opposite sides of the corresponding first or second groove axis.

18. The clamp of claim 16, wherein the first protrusion defines a width that is wider than a width of the first groove.

19. The clamp assembly of claim 16, wherein the second groove is included in a plurality of grooves on the second plate to selectively receive the conductor in cooperation with the first groove, the plurality of grooves further including:
a third groove substantially parallel to the second groove;
a fourth groove substantially perpendicular to the first and third grooves; and
a fifth groove substantially parallel to the fourth groove.

20. The clamp assembly of claim 19, wherein a protrusion extends, respectively, from each of the third, fourth, and fifth grooves, to a distal end that protrudes outside of the corresponding third, fourth, or fifth groove to engage the conductor.
